(19) United States
(12) Patent Application Publication
(10) Pub. No.: US 2016/0217366 A1
(43) Pub. Date: Jul. 28, 2016

(54) Portfolio Optimization Using Neural Networks

(71) Applicant: Jianjun Li, Warren, NJ (US)

(72) Inventor: Jianjun Li, Warren, NJ (US)

(21) Appl. No.: 14/575,817

(22) Filed: Jan. 23, 2015

(51) Int. Cl. G06N 3/08; G06Q 40/06; G06N 3/04

(52) U.S. Cl. CPC G06N 3/08; G06N 3/04; G06Q 40/06

(57) ABSTRACT

A new method for stock selection, portfolio optimization and asset allocation using specially constructed neural networks and ranking algorithms. Each stock in a portfolio is modeled by a neural network designed to learn from the statistical differences between the stock and the target benchmark. The neural network outputs, representing each model's forward looking rate of return (FLRoR) relative to the benchmark, are then ranked in descending order. Portfolio optimization is performed by rebalancing the positions based on their FLRoR rankings subject to the portfolio constraints including regulatory requirements and risk level. The method has been implemented in computer programs.

### BRIEF SUMMARY

### Background of the Invention

Neural Networks, a big branch of computer artificial intelligence, are a set of statistical learning algorithms that can be used to handle complex functions that depend on a large number of inputs and are difficult to define mathematically. Voice recognition, hand-writing recognition and face detection are real world applications of the technology. Neural Networks are also used for stock market analysis. The inventor, Jianjun Li, developed one of the first commercial software products based on neural networks for stock analysis back to 1995. Details were published in www.deepinsight.com. However, all existing products, designs and research papers are using neural networks for price prediction or bullish/bearish prediction. Most of them just use historical prices to train the neural networks. None of them are modeling the statistical relationship between inputs and forward looking rate of returns. None of them are able to compare or rank, statistically, the forward looking performance of stocks within a portfolio, which is important for portfolio optimization.

### SUMMARY OF THE INVENTION

The present invention is a brand new method for computer based stock selection, portfolio optimization and asset allocation with neural networks. The system collects all major fundamental data, trading data and market information for the past 10 years, then uses the data to train the neural networks and model the relationship between inputs and Forward Looking Rate of Return (FLRoR) for each stock in a portfolio. When the neural networks are trained, the system produces FLRoRs in a daily or weekly basis. Stock selection, portfolio optimization and asset allocation can then be effectively performed based on the FLRoR numbers.

There are four key items in this invention:
(1) It's the first neural network system to take fundamental data, market information and technical indicators all together as input.
(2) It's the first neural network system to model the statistical relationship between combined input data and Forward Looking Rate of Return (FLRoR). Because the neural networks are trained with relative performance (stock's FLRoR—benchmark's FLRoR), the common factors driving the stocks and the benchmark movement are filtered out and the model makes more sense for portfolio optimization.
(3) New controlled learning algorithms are developed to pull the neural networks out of local minima during training.
(4) It's the first neural network system to reveal, quantitatively, the statistical contribution of each input element to the stock performance. For example, the percent contribution from the P/E ratio, the percent contribution from a technical indicator MACD cross-over, etc.

### DRAWING DESCRIPTION: BRIEF DESCRIPTION OF THE DRAWINGS

FIG. 1 is a configuration of the neural network of the present invention.

Inputs:
X₁=Price/Earnings Ratio
X₂=Price/Sales Ratio
X₃=Price/Book Value
X₄=Price/Cash Flow Per Share
X₅=Revenue Growth (year over year)
X₆=Earnings Growth (year over year)
X₇=Dividend Yield
X₈=Payout
X₉=Return on Assets
X₁₀=Return on Equity
X₁₁=Operating Margin
X₁₂=Profit Margin
X₁₃=Debt/Equity Ratio
X₁₄=Shares Short %
X₁₅=Mean Analyst Rating (1.0-5.0)
X₁₆=EPS Surprise % (Actual EPS−Estimate)/Estimate
X₁₇=EBIT
X₁₈=Volatility
X₁₉=Company News (Bullish/Bearish coding)
X₂₀=Interest rate (10 y notes yield)
X₂₁=MACD
X₂₂=Money Flow RSI
X₂₃=Accumulation/Distribution
X₂₄=Aroon Oscillator
X₂₅=Sharpe Ratio
X₂₆=Relative Strength to Benchmark
X₂₇=Closing Price
X₂₈=Trading Volume
X₂₉=Benchmark Price
X₃₀=Benchmark Volatility

Outputs:
When the neural networks are trained, feed input data at time t, t from 10 years ago to current date, set the learning targets as:

FLRoR₁(t)=SRoR_{1w}(t)−BRoR_{1w}(t)

FLRoR₂(t)=SRoR₁ₘ(t)−BRoR₁ₘ(t)

FLRoR₃(t)=SRoR_{1q}(t)−BRoR_{1q}(t)
Where:
SRoR_{1w}(t): Stock's 1-week Forward Looking Rate of Return at time t
BRoR_{1w}(t): Benchmark's 1-week Forward Looking Rate of Return at time t
SRoR₁ₘ(t): Stock's 1-month Forward Looking Rate of Return at time t
BRoR₁ₘ(t): Benchmark's 1-month Forward Looking Rate of Return at time t
SRoR_{1q}(t): Stock's 1-quarter Forward Looking Rate of Return at time t
BRoR_{1g}(t): Benchmark's 1-quarter Forward Looking Rate of Return at time t
Let SP(t) represent the stock price at time t, BP(t) the benchmark price at time t:

SRoR_{1w}(t)=(SP(t+1 week)−SP(t))/SP(t)

SRoR₁ₘ(t)=(SP(t+1 month)−SP(t))/SP(t)

SRoR_{1q}(t)=(SP(t+1 quarter)−SP(t))/SP(t)

BRoR_{1w}(t)=(BP(t+1 week)−BP(t))/BP(t)

BRoR₁ₘ(t)=(BP(t+1 month)−BP(t))/BP(t)

BRoR_{1q}(t)=(BP(t+1 quarter)−BP(t))/BP(t)
In production mode, the neural networks output FLRoR₁, FLRoR₂, FLRoR₃ as defined above.

Controlled Learning:
Neural networks are generally trained with back-propagation algorithms. For complex neural networks like these, back-propagation algorithms are not guaranteed for network convergence. To avoid local minima, controlled learning or new algorithms are developed for the neural networks training. For example, when a company earnings increase, the stock performance should respond positively. If we see a negative response during training, the neuron weights are adjusted to pull the training process out of a possible local minima.

Neural Network Configuration:
Three or Four Layers: One input layer, one output layer, one or two hidden layers.
Number of input nodes: 10 to 30 configurable
Number of hidden nodes: 20 to 60 configurable
Number of Outputs: One or multi-period of FLRoRs configurable.
Activation Function: f(x)=−1+2/(1+exp(−x))

FIG. 2 is a block diagram of the system based on the present invention:

Input Module:
Collects fundamental data, trading data and market data from the internet. Pre-process the
raw data to a format suitable for the neural networks.

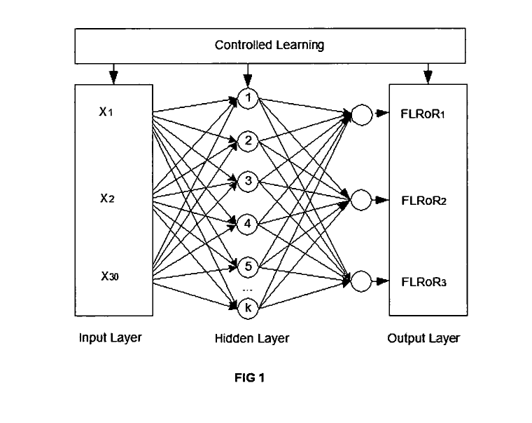

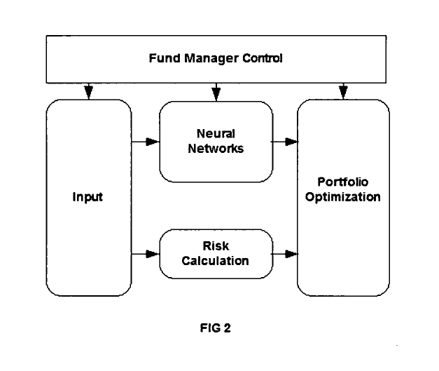

Neural Networks:
The core of the system, illustrated in FIG. 1.

Risk Calculation:
This module calculates the risk at security level and portfolio level for fund managers to apply risk adjusted strategies.

Portfolio Optimization:
Allocate investment weights to individual stocks of the portfolio based on the neural network outputs—FLRoRs and risk control strategy.

Fund Manager Control:
The control module gives fund managers or users the options to select neural network configuration, associated benchmarks and asset allocation strategies including risk control.

### DETAILED DESCRIPTION: DESCRIPTION OF THE PREFERRED EMBODIMENTS

With reference to the drawings FIG. 1 and FIG. 2 and the drawing descriptions, the present invention uses neural networks to model and reveal the statistical relationship between the inputs and Forward Looking Rate of Return (FLRoR). The system collects up to 10 year input data as listed in the drawing description section, calculates the FLRoRs for different periods (for example one week, one month and one quarter) and then trains the neural networks through Controlled Learning. After training, the artificial neural networks learnt the statistics and became an expert for what data would contribute, and how much by probability, to the stock performance. In production mode, the system takes the current input data, produces the FLRoRs of every securities in a portfolio or a watch list. Stock selection, portfolio optimization or asset allocation can then be performed based on the FLRoR numbers as follows:

(1) For Stock Selection:

Ranks the FLRoRs in descending order. A stock with a higher FLRoR will outperform a stock with a lower FLRoR, statistically.

(2) For Portfolio Optimization:

If FLRoR>0, it indicates the security would outperform the benchmark statistically. The higher the number, the higher the probability that the security will outperform. Therefore, more investment weights may be given to those securities in the portfolio.

If FLRoR<0, it indicates the security would underperform the benchmark statistically. The lower the number, the higher the probability that the security will underperform. Therefore less funds should be allocated to those securities in the portfolio.

If FLRoR=0, the security and the benchmark would perform the same, statistically.

Users can also select more periods of Rate of Return as output. For example, One-week FLRoR, One month FLRoR and one quarter FLRoR as illustrated in FIG. 1. In the case of multiple FLRoRs, the outputs are summed and normalized to a single number, called Average Forward Looking Rate of Return (AFLRoR) which ranges between −1 and +1, used as follows:

If AFLRoR>0, it indicates the security would outperform the benchmark statistically. The higher the number, the higher chance the security will outperform. Therefore, more weights may be given to those securities in the portfolio.

If AFLRoR<0, it indicates the security would underperform the benchmark statistically. The lower the number, the higher chance the security will underperform. Therefore less funds should be allocated to those securities in the portfolio.

If AFLRoR=0, the security and the benchmark would perform the same, statistically.

(3) For Data Mining:

The neural network output is a combination of all inputs, neuron values and connection weights. By setting all inputs, except one input, to zero, we'll know the quantitative contribution from that input for the time t. By averaging the contributions over 10 year history, we'll get the statistical number called Influence Factor. With that, we will know what the most important factors are for the stock performance.

The system is implemented with computer programs.

What is claimed is:

1. A method for stock selection, arbitrage trading and portfolio optimization comprising the following:
1.1: Construct the Neural Network Inputs
For each stock in an investment portfolio, collect its historical data (default setting is 10 years, but configurable from 5 to 20 years) as listed in FIG. 1 DRAWING DESCRIPTION as Inputs. For the portfolio, pick up a public or private benchmark the portfolio manager aims to beat. Process the inputs into time series in the way described below:
X₁=PEₛ−PE_{b}
Where PEₛ is the stock's PE Ratio, PE_{b} the benchmark's average PE Ratio.
X₂=PSₛ−PS_{b}
Where PSₛ is the stock's PS Ratio, PS_{b} the benchmark's average PS Ratio.
X₃=PBₛ−PB_{b}
Where PBₛ is the stock's PB Ratio, PB_{b} the benchmark's average PB Ratio.
X₄=PCₛ−PC_{b}
Where PCₛ is the stock's PC Ratio, PC_{b} the benchmark's average PC Ratio.
X₅=RGₛ−RG_{b}
Where RGₛ is the stock's Revenue Growth rate in 1 year,
RG_{b} is the benchmark's average Revenue Growth rate in 1 year.
X₆=EGₛ−EG_{b}
Where EGₛ is the stock's Earning Growth rate in 1 year,
EG_{b} is the benchmark's average Earning Growth rate in 1 year.
X₇=DYₛ−DY_{b}
Where DY_{b} is the stock's Dividend Yield,
DY_{b} is the benchmark's average Dividend Yield.
X₈=POₛ−PO_{b}
Where POₛ is the stock's Payout, PO_{b} is the benchmark's average Payout.
X₉=ROAₛ−ROA_{b}
Where ROAₛ is the stock's Return On Assets,
ROA_{b} is the benchmark's average Return On Assets.
X₁₀=ROEₛ−ROE_{b}
Where ROEₛ is the stock's Return On Equity,
ROE_{b} is the benchmark's average Return On Equity.
X₁₁=OMₛ−OM_{b}
Where OMₛ is the stock's Operating Margin,
OM_{b} is the benchmark's average Operating Margin.
X₁₂=PMₛ−PM_{b}
Where PMₛ is the stock's Profit Margin,
PM_{b} is the benchmark's average Profit Margin.
X₁₃=DEₛ−DE_{b}
Where DEₛ is the stock's Debt/Equity Ratio,
DE_{b} is the benchmark's average Debt/Equity Ratio.
X₁₄=SSRₛ−SSR_{b}
Where SSRₛ is the stock's Shares Short Ratio,
SSR_{b} is the benchmark's average Shares Short Ratio.
X₁₅=MARₛ−MAR_{b}
Where MARₛ is the stock's Mean Analyst Rating,
MAR_{b} is the benchmark's average rating of its constituents.
X₁₆=EPSSₛ−EPSS_{b}
Where EPSSₛ is the stock's EPS Surprise %,
EPSS_{b} is the benchmark's average EPS Surprise %.
X₁₇=EBITₛ−EBIT_{b}
Where EBITₛ is the stock's Earnings Before Interest and Tax,
EBIT_{b} is the benchmark's average Earnings Before Interest and Tax.
X₁₈=VIXₛ
Where VIXₛ is the stock's Volatility.
X₁₉=CAₛ
Where CAₛ is the stock's Corp. Action mapped to a range (−1, +1) with −1 representing the very bearish action and +1 the very bullish action.
X₂₀=IR
Where IR is the Market Interest rate (10 y notes yield)
X₂₁=MACDₛ
The stock's MACD Indicator.
X₂₂=MRSIₛ
The stock's Money Flow Relative Strength Index.
X₂₃=ADₛ
The stock's Accumulation/Distribution Indicator.
X₂₄=AOSC
The stock's Aroon Oscillator
X₂₅=SRₛ−SR_{b}
Where SRₛ is the stock's Sharpe Ratio,
SR_{b} is the benchmark's average Sharpe Ratio.
X₂₆=RSB
The stock's Relative Strength to the Benchmark.
X₂₇=CPₛ
The stock's Closing Price.
X₂₈=TV
The stock's Trading Volume.
X₂₉=BV_{b}
The benchmark's Closing Value.
X₃₀=VIX_{b}
The benchmark's Volatility
Notes: X₁, X₂ . . . X₃₀ above are inputs at time t, t from 10 years ago to current day.
− is a minus math operator, ie, the stock value minus the average benchmark value.
1.2: Construct the Neural Network Targets
Construct the historical data into 3 time series as the Neural Network targets as listed in FIG. 1 DRAWING DESCRIPTION:
TFLRoR₁=SRoR_{1w}−BRoR_{1w}
TFLRoR₂=SRoR₁ₘ−BRoR₁ₘ
TFLRoR₃=SRoR_{1q}−BRoR_{1q}
Where:
SRoR_{1w}: Stock's 1-week Forward Looking Rate of Return
BRoR_{1w}: Benchmark's 1-week Forward Looking Rate of Return
SRoR₁ₘ: Stock's 1-month Forward Looking Rate of Return
BRoR₁ₘ: Benchmark's 1-month Forward Looking Rate of Return
SRoR_{1q}: Stock's 1-quarter Forward Looking Rate of Return
BRoR_{1q}: Benchmark's 1-quarter Forward Looking Rate of Return
1.3: Construct the Neural Networks
Construct the Neural Network as described in FIG. 1 DRAWING DESCRIPTION:
Layers: One input layer, one output layer, one or two hidden layers configurable.
Number of input nodes: 10 to 30 configurable
Number of hidden nodes: 20 to 60 configurable
Number of Outputs: 1 to 3 configurable.
Activation Function:
$$f ( x ) = - 1 + \frac{2}{1 + exp ( - x )}$$
Initialize the neural networks with random numbers.
1.4: Train the Neural Networks
Conduct neural network training and calibration as follows:
1.4.1 Take a stock from the portfolio, process steps 1.1 to 1.2 above, which produce one time series for the neural network input and 3 time series for the neural network target.
1.4.2 Feed the neural network with X₁ to X₃₀ at time t.
1.4.3 Calculate Hidden Node Values of the Neural Networks:
The ith Hidden Node value:
$${HN}_{i} = - 1 + \frac{2}{1 + exp ( - {S}_{i} )}$$
Where:
Sᵢ=Σⱼ₌₁³⁰Wᵢⱼ*Xⱼ+PHNᵢ
i from 1 to K as shown in FIG. 1, K is the number of Hidden Nodes.
Wᵢⱼ is the neural weight between Hidden Node i and Input Node j.
Xⱼ is the jth Input as defined in Step 1.1 above.
PHNᵢ is the ith Hidden Node Value from Previous Training Cycle.
1.4.4 Calculate the Output Values of the Neural Networks:
Output 1:
$${FLRoR}_{1} = - 1 + \frac{2}{1 + exp ( - {S}_{1} )}$$
Where:
S₁=Σᵢ₌₁^{k}Wᵢ₁*HNᵢ+PFLRoR₁
Wᵢ₁ is the neural weight between Hidden Node i and Output Node 1.
HNᵢ is the ith Hidden Node value calculated in Step 1.4.3.
PFLRoR₁ is the Output 1 from Previous Training Cycle.
Output 2:
$${FLRoR}_{2} = - 1 + \frac{2}{1 + exp ( - {S}_{2} )}$$
Where:
S₂=Σᵢ₌₁^{k}Wᵢ₂*HNᵢ+PFLRoR₂
Wᵢ₂ is the neural weight between Hidden Node i and Output Node 2.
HNᵢ is the ith Hidden Node value calculated in Step 1.4.3.
PFLRoR₂ is the Output 2 from Previous Training Cycle.
Output 3:
$${FLRoR}_{3} = - 1 + \frac{2}{1 + exp ( - {S}_{3} )}$$
Where:
S₃=Σᵢ₌₁^{k}Wᵢ₃*HNᵢ+PFLRoR₃
Wᵢ₃ is the neural weight between Hidden Node i and Output Node 3.
HNᵢ is the ith Hidden Node value calculated in Step 1.4.3.
PFLRoR₃ is the Output 3 from Previous Training Cycle.
1.4.5 Calculate the error between the Output and the Target:
E₁=FLRoR₁−TFLRoR₁
E₂=FLRoR₂−TFLRoR₂
E₃=FLRoR₃−TFLRoR₃
1.4.6 Update the Neural Network
Adjust the neural network weights using standard back-propagation algorithm.
Set t+1→t, repeat 1.4.2 to 1.4.6 and run through the entire time series.
1.4.7 Calibrate the Neural Networks using computer generated artificial data For each neural network input X₁, X₂ . . . X₃₀, generate a trending and above (or below) historical average data series, Y₁, Y₂ . . . Y₃₀. Test the neural network by replacing Xᵢ with Yᵢ one at a time. If the neural network does not work as expected, adjust the neural network weights and node values to correctly reflect the trending inputs. For example, X₁₂ is profit margin, we generate a time series Y₁₂ with increasing profit margins over time. In the real world, when a company's profit margin increases, its stock performance should improve in general. When replacing X₁₂ with Y₁₂ as input, the neural network should act positively, if not or act in opposite direction, the neural network is most likely in local minima. In this case, pull the neural network out of the local minima by adjusting the weights linked to the input node. Continue re-training.
1.4.8 Set t to 1, repeat 1.4.2 to 1.4.7 until the Outputs are very close to the Targets such that:
MSE(E₁)<0.01
MSE(E₂)<0.01
MSE(E₃)<0.01
Where:
MSE(E₁) is the Mean Squared Error of E₁ time series.
MSE(E₂) is the Mean Squared Error of E₂ time series
MSE(E₃) is the Mean Squared Error of E₃ time series
1.4.9 Take the next stock from the portfolio and repeat 1.4.1 to 1.4.8 until all stocks in the portfolio are processed and the neural networks are trained.
When the neural networks are trained, use the current outputs for Stock Selection, Arbitrage Trading and Portfolio Optimization as explained in 1.5, 1.6 and 1.7 below.
1.5: Stock Selection
Create a Watch List containing N stocks that the fund manager is interested. Create N Neural Networks for the N stocks, then follow Step 1.1 to 1.4 above. When the neural networks are trained, feed each neural network with current day input data X_{1,} X₂ . . . X₃₀, and generate a output, FLRoR, for each stock. Rank the FLRoR values in descending order such as:
FLRoR¹>=FLRoR²>= . . . >=FLRoR^{N}
Where:
FLRoR¹ is the Neural Network output of stock1 that has the highest output. Statistically, stock1 would outperform stock2 and stock2 would outperform stock3, so on so forth. Fund managers or individual investors, therefore, can select the stocks with high and positive FLRoRs to buy, or sell the ones with negative FLRoRs. Depending on the portfolio style, the fund manager can select 1-week output (FLRoR₁) or 1-month (FLRoR₂) or 1-quarter (FLRoR₃).
1.6: Arbitrage Trading
To analyze the statistical arbitrage of Stock A and Stock B, create a neural network for Stock A and select Stock B as the target benchmark (Private Benchmark) as outlined in step 1.1 to 1.4 above. When the neural network is trained and run, the fund manager gets a neural network output, FLRoR^{A}. If FLRoR^{A}>0, it indicates Stock A would outperform Stock B; if FLRoR^{A}<0, it indicates Stock A would underperform Stock B, statistically. Arbitrage trading strategy, therefore, can be used.
1.7: Portfolio Optimization
Given a portfolio P with N stocks and one Cash position, follow the steps below to optimize the portfolio:
1.7.1 Create N neural networks
Using the methods from 1.1 to 1.4 above, produce a neural network output for each stock of the portfolio, then rank the outputs of all N stocks in descending order as follows:
FLRoR¹>=FLRoR²>= . . . >=FLRoR^{N}
Where:
FLRoR¹ is the Neural Network output of stock1 that has the highest output,
FLRoR² is the Neural Network output of stock2 that has the 2^{nd} highest output,
. . .
FLRoR^{N} is the Neural Network output of stockN that has the lowest output.
1.7.2 Assign the allowed highest weight, W¹, to stock1 and make:
W¹>=W²>= . . . >=W^{N}
Where:
W¹ is the percentage of the dollar amount invested to stock1,
W² is the percentage of the dollar amount invested to stock2,
W^{N} is the percentage of the dollar amount invested to stockN,
W^{C} is the percentage of the Cash amount, and
Σᵢ₌₁^{N}Wⁱ+W^{C}=100%
Assuming the total market value of the portfolio is M^{P}, the market value of position i is
Mⁱ=Wⁱ*M^{P}
And the cash amount of the portfolio is
M^{C}=W^{C}*M^{P}
And
M^{P}=Σᵢ₌₁^{N}Mⁱ+M^{C}
1.7.3 Apply portfolio constraints
Control Risk: Optimize the portfolio so that portfolio risk<benchmark risk:
Let VaRₚ denote the Value-at-Risk of the portfolio P, VaR_{b} the Value-at-Risk of the target benchmark. Both VaRₚ and VaR_{b} are by %.
If VaRₚ>VaR_{b}, then reduce the Nth stock weight by ΔW and increase the Cash weight by ΔW:
W^{N}−ΔW→W^{N}, W^{C}+ΔW→W^{C}
Since Cash has zero risk, the new portfolio risk should be lower now. Recalculate VaRₚ. If VaRₚ is still greater than VaR_{b}, reduce the weight of the next stock in the rank (as listed in 1.7.2):
W^{N-1}−ΔW→W^{N-1}, W^{C}+ΔW→W^{C}
Recalculate VaRₚ and reduce W^{N-2}, W^{N-3} . . . as needed, until VaRₚ<=VaR_{b}.
The cash weight is increased but the portfolio remains in optimal fashion:
W¹>=W²>= . . . >=W^{N}
Σᵢ₌₁^{N}Wⁱ+W^{C}=100%
VaRₚ<=VaR_{b}
Control Concentration: If a fund is regulated, compliance rules must be met. Typically, a fund can only invest a certain % into an individual company or stock. Assume W^{max} is the maximum percentage allowed, the portfolio is then optimized as follows:
W¹=W^{max}
W¹>=W²>= . . . >=W^{N}
Σᵢ₌₁^{N}Wⁱ+W^{C}=100%
1.8: Implementation
The said method and the steps 1.1 to 1.7 above are implemented in computer programs using language Java, .NET, or C++. The programs rim under Windows, Linux, Unix or MAC OS. The computer programs give users the flexibility to setup or control the following:
1.8.1 Create portfolios and watchlists consisting of any stocks traded in the markets.
1.8.2 Select a public index as target benchmark of each portfolio.
1.8.3 Create Private Benchmarks and use a Private Benchmark in a portfolio.
1.8.4 Configure the Neural Networks such as changing the number of input nodes, the number of hidden layers, the number of output nodes and the length of historical data for neural network training.
1.8.5 Setup portfolio constraints including Maximum/Minimum weighting per stock, Maximum/Minimum numbers of stocks per portfolio, Maximum/Minimum weighting of Cash, Portfolio VaR level.
1.8.6 Schedule batch jobs to download data, perform machine learning and portfolio optimization at specified time with daily, weekly or monthly frequency.
